(19) United States
(12) Patent Application Publication
(10) Pub. No.: US 2015/0097737 A1
(43) Pub. Date: Apr. 9, 2015

(54) MODULAR ANTENNA ASSEMBLIES FOR WIRELESS SYSTEMS

(71) Applicant: CORNING OPTICAL COMMUNICATIONS RF LLC, Glendale, AZ (US)

(72) Inventor: Jeevan Kumar Vemagiri, Peoria, AZ (US)

(21) Appl. No.: 14/504,668

(22) Filed: Oct. 2, 2014

Related U.S. Application Data
(60) Provisional application No. 61/887,723, filed on Oct. 7, 2013.

(51) Int. Cl. H01Q 1/24; H01Q 1/50

(52) U.S. Cl. CPC H01Q 1/24; H01Q 1/50
USPC 343/702

(57) ABSTRACT

A modular antenna assembly for a wireless communication system. The assembly includes an housing, an antenna substrate, a connection block, and an interconnect. The antenna substrate has an antenna formed thereon and is mounted in the housing. The connection block is attached to the antenna substrate. The interconnect has a first end and a second end, is electrically connected to the antenna through the connection block at the first end, and is configured to releasably attach the antenna substrate to another component of the wireless system. The antenna electrically connects to the another component through the interconnect at the second end. The another component is attached to a structure.

### RELATED APPLICATIONS

This application claims the benefit of priority under 35 U.S.C §119 of U.S. Provisional Application No. 61/887,723 filed Oct. 7, 2013, the content of which is relied upon and incorporated herein by reference in its entirety.

### BACKGROUND

1. Field of the Disclosure

The disclosure relates generally to antenna assemblies for wireless systems, and, in particular to antenna assemblies that are modular.

2. Technical Background

One of the most important components of the wireless systems is the antenna that is responsible for wireless communication. The antenna due to its size and radiation responsibility poses the greatest packaging challenge to the wireless system packaging engineer. At the same time, it is also the antenna, a critical link in the system performance, which usually is the highest penalty bearer in performance (compared to other transceiver components) due to the traditional practice of realizing the antenna on the same substrate or directly above the substrate on which the active transceiver circuitry resides. Also, the increased implementation of MIMO (multiple input and multiple output) antenna systems, has further increased the challenge of antenna-element integration, even in the K-band (18 GHz-27 GHz) applications, for Satellite communications and radar applications, where the size of the antenna is about a tenth smaller than the L-band (1-2 GHz). The performance of the antenna is highly sacrificed on account of the substrate selection, and size constraints while packaging the different components of the wireless system.

### SUMMARY

Embodiments disclosed herein include a modular antenna assembly for a wireless communication system. The assembly includes an antenna substrate having an antenna formed thereon, and an interconnect configured to releasably attach the antenna substrate to another component of the wireless system. The antenna is electrically connected to the another component through the interconnect.

One embodiment of the disclosure relates to a modular antenna assembly for a wireless communication system. The assembly includes an housing, an antenna substrate, an n-position block, and a push-on interconnect. The antenna substrate is mounted in the housing and has an antenna formed thereon and mounted in the housing. The n-position block is attached to the antenna substrate. The push-on interconnect has a first end and a second end, is electrically connected to the antenna through the n-position block at the first end, and is configured to releasably attach the antenna substrate to another component of the wireless system. The antenna electrically connects to the another component through the push-on or a screw-on interconnect at the second end. The another component is attached to a structure.

Additional features and advantages will be set forth in the detailed description which follows, and in part will be readily apparent to those skilled in the art from the description or recognized by practicing the embodiments as described in the written description and claims hereof, as well as the appended drawings.

It is to be understood that both the foregoing general description and the following detailed description are merely exemplary, and are intended to provide an overview or framework to understand the nature and character of the claims.

The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a block diagram of an antenna assembly positioned inside of the structure in which the non-radiative components of the wireless system are located;

FIG. 2 is a block diagram of an antenna assembly positioned outside of the structure in which the non-radiative components of the wireless system are located;

FIG. 3 is a diagrammatic, plan view of an exemplary embodiment of a modular antenna assembly positioned externally to the structure in which the non-radiative components of the wireless system are located and connected to the wireless system by an interconnect;

FIG. 4 is a is a diagrammatic, plan view of the modular antenna assembly illustrating positioned externally to the structure in which the non-radiative components of the wireless system are located and connected to the modular wireless system by a plurality of interconnects;

FIG. 5 is a diagrammatic cross-section view of the antenna assembly of FIGS. 3 and 4;

FIG. 6 is a is a diagrammatic, plan view of an exemplary embodiment of a modular antenna assembly positioned internally of the structure in which the non-radiative components of the wireless system are located and connected to the wireless system by an interconnect;

FIG. 7 is a diagrammatic, plan view of an exemplary embodiment of a modular antenna assembly positioned internally of the structure in which the non-radiative components of the wireless system are located and connected to the wireless system by a plurality of interconnects;

FIG. 8 is a diagrammatic, cross-section view of the modular antenna assembly of FIGS. 7 and 8;

FIG. 9 is a diagrammatic, side view of an exemplary embodiment of a modular antenna assembly positioned internally to the structure in which the non-radiative components of the wireless system are located and connected to the wireless system by an interconnect and having a small thickness antenna substrate located on the top step of the antenna assembly;

FIG. 10 is a is a diagrammatic, side view of an exemplary embodiment of a modular antenna assembly positioned internally to the structure in which the non-radiative components of the wireless system are located connected to the wireless system by an interconnect and having a medium thickness antenna substrate located on the middle step of the antenna assembly;

FIG. 11 is a diagrammatic, side view of an exemplary embodiment of a modular antenna assembly positioned internally of the structure in which the non-radiative components of the wireless system are located connected to the wireless system by an interconnect and having a large thickness antenna substrate located on the bottom step of the antenna assembly;

FIG. 12 is a diagrammatic, partial perspective view of a single interconnect connected at the first end to a block to provide for electrical connection to an antenna, and at the second end to a male connector to provide connection through a trace to other components of the wireless communication system in a straight orientation;

FIG. 13 is a diagrammatic, partial perspective view of a plurality of interconnects connected at their first ends to a block to provide for electrical connections to a plurality of antennas, and at their second ends to male connectors to provide connections through a traces to other components of the wireless communication system in a straight orientation;

FIG. 14 is a diagrammatic, partial perspective view of a single interconnect connected at the first end to a block to provide for electrical connection to an antenna, and at the second end to a male connector to provide connection through a trace to other components of the wireless communication system in a right angle orientation;

FIG. 15 is a diagrammatic, partial perspective view of a plurality of interconnects connected at their first ends to a block to provide for electrical connections to a plurality of antennas, and at their second ends to male connectors to provide connections through a traces to other components of the wireless communication system in a right angle orientation;

FIG. 16 is a diagrammatic, top, perspective view of an exemplary embodiment of a housing and block of the modular antenna assembly with the top removed showing the step elevations of the antenna assembly;

FIG. 17A is a diagrammatic, front, exploded perspective view of an exemplary embodiment of a housing of a modular antenna assembly, which would be located externally to the structure in which the non-radiative components of the wireless system are located;

FIG. 17B is a diagrammatic, front, assembled perspective view of the modular antenna assembly of FIG. 17A;

FIG. 18A is a diagrammatic, front, exploded perspective view of an exemplary embodiment of a housing and n-position block of a modular antenna assembly, which would be located internally of the structure in which the non-radiative components of the wireless system are located;

FIG. 18B is a diagrammatic, front, assembled perspective view of the modular antenna assembly of FIG. 18B;

FIG. 19 is a diagrammatic, front, assembled perspective view of the modular antenna assembly of FIG. 18A showing an attachment feature in to attach the modular antenna assembly to the structure in which the non-radiative components of the wireless system are located.

### DETAILED DESCRIPTION

Embodiments disclosed herein include a modular antenna assembly for a wireless communication system. The assembly includes a housing, an antenna, a connection block, and an interconnect. The antenna is formed or mounted on an antenna substrate which is mounted in the housing and connected to the connection block which is located in the housing. The interconnect has a first end and a second end, attaches to the connection block at the first end and electrically connects to the antenna through the connection block. The interconnect is configured to releasably attach to another component of the wireless system at the second end to electrically connect the antenna to the other component at the second end. The other component may be located in and attached to a structure separate from the housing.

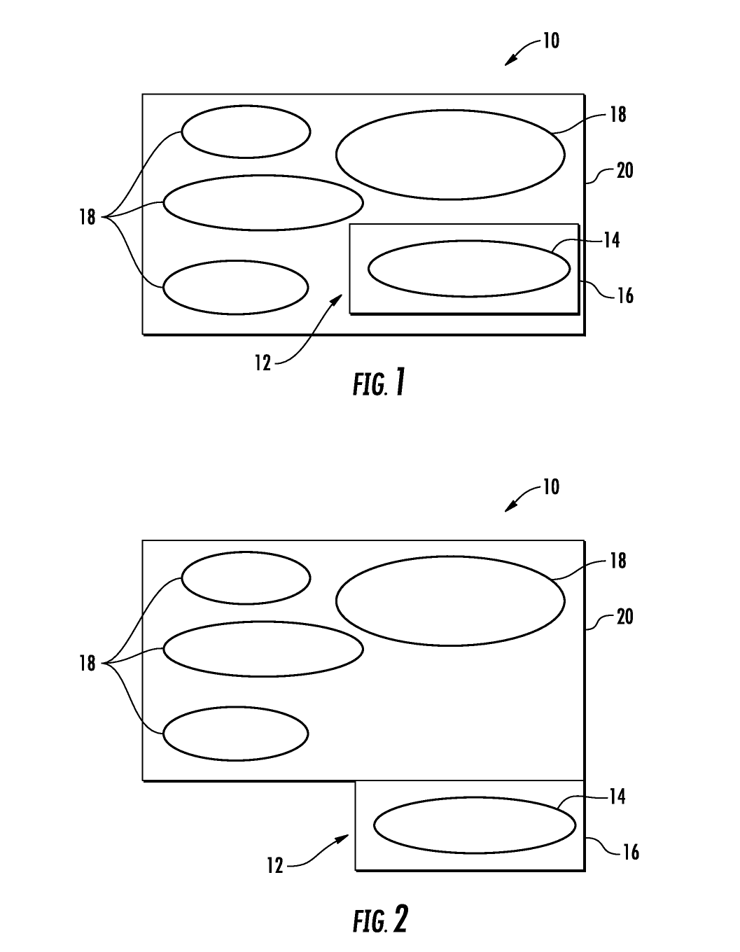

FIGS. 1 and 2 illustrate block diagrams of wireless communication system 10 having modular antenna assembly 12 which includes antenna 14 in housing 16. Housing 16 which may be any type of housing, enclosure, chassis, or the like, separates modular antenna assembly 12 from one or more of other components 18 of the wireless communication system 10. Other components 18 may include any other components of the wireless communication system, as non-limiting example, non-radiative components. Non-radiative components may include, as examples, filters, oscillators, mixers and other electrical components. In FIGS. 1 and 2, other components 18 are shown located in a structure 20. Structure 20 may be any type of structure on, in or at which the other components 18 may be located, positioned, mounted, secured, attached, etc. Accordingly, as non-limiting examples, the structure 20 may include, without limitation, a mounting surface, a substrate, a chassis, a housing, an enclosure, a frame, or the like. In FIG. 1, modular antenna assembly 12 is shown located within or internal to structure 20 in which other components 18 are located, while in FIG. 2, the modular antenna assembly 12 is shown located outside of or external of structure 20 in which other components 18 are located.

Having modular antenna assembly 12 separate from other components 18 of the wireless communication system 10 allows more freedom for antenna 14 design and thus aids in the performance enhancement of antenna 14. One advantage may include having a different substrate for antenna 14 than substrate for the other components 18. In this manner, properties such as substrate size, thickness and type, which may affect the performance of antenna 14 and other components 18. Also, antenna 14 feed circuitry for phased array radar applications can incorporate on the antenna substrate and not take up space on a substrate or surface associated with structure 20. Additionally, having a modular antenna assembly 12 located within or internal to structure 20 eliminates the need for lengthy cables between other components 18 and antenna 14 contributing to cost savings.

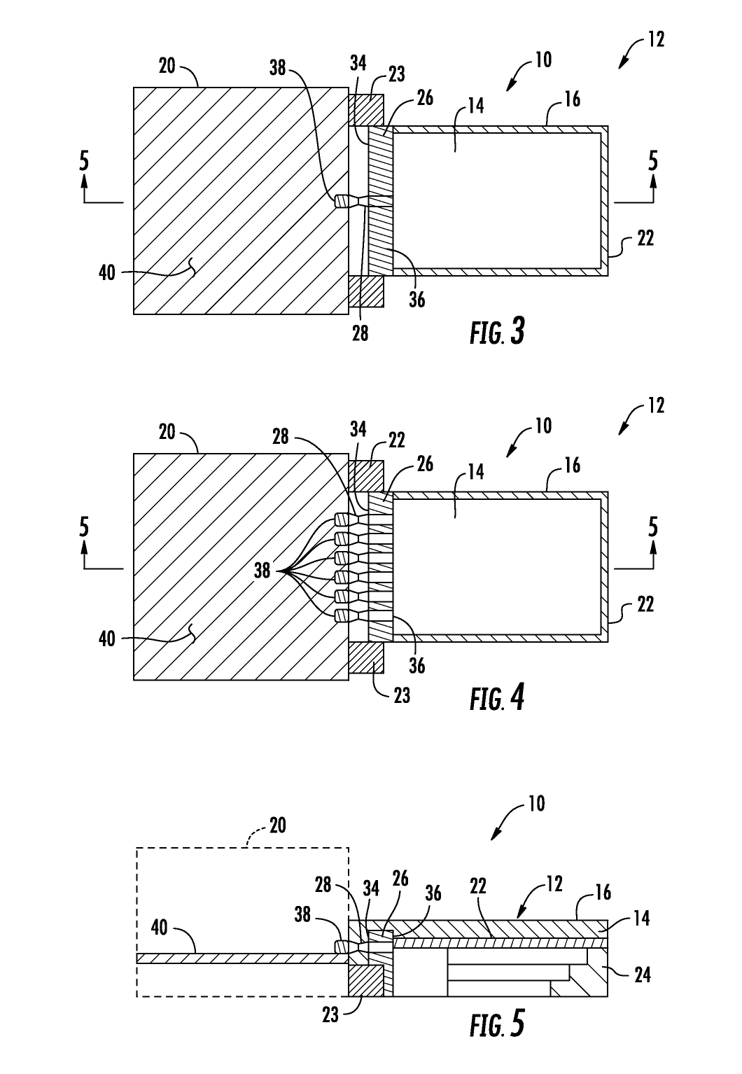

To further describe the arrangement of modular antenna assembly 12 with respect to other components 18 of wireless communication system 10, FIGS. 3, 4, and 5 illustrate diagrammatic views of wireless communication system 10 having antenna assembly 12 located outside of or external to structure 20. FIGS. 3 and 4 are plan views of housing 16 and structure 20 of wireless communication system 10 showing a general arrangement of interiors of housing 16 and structure 20, while FIG. 5 is a cross-section cut through the housing 16 and structure 20. Housing 16 attaches to structure 20 using attachment feature 23. Attachment feature 23 may be any suitable component or device that provides for secure, removable mechanical attachment of housing 16 to the structure 20 and may include, as non-limiting examples, flanges, brackets, tabs, or the like, which may use any suitable fastener such as screws, pins, and the like, and/or, have press fit interfacing surfaces.

Antenna 14 may be mounted or formed on antenna substrate 22. Antenna substrate 22 is positioned in housing 16 and may be located or mounted on one of a plurality of steps 24. The steps 24 allow antenna substrate 22, and, thereby, antenna 14, to be mounted at different levels in the housing 16. In this manner, steps 24 allow certain flexibility in adjusting antenna 14 to take into account electromagnetic variations, such as gain, which may be due to antenna substrate 22 structural variations. Steps 24 and different antenna 14 mounting levels will be discussed further below. Antenna substrate 22 connects to connection block 26 to which interconnect 28 connects and provides for a stable electrical connection between interconnect 28 and antenna 12. Connection block 26 may also be referred to as an “n-position block”, with “n” representing the number of positions to which interconnects 28 may be connected. In other words, connection block 26 has positions for n number of interconnects 28, with n being any number. Connection block 26 may be a GPO®, GPPO®, G3PO™ or G4PO® smooth bore n position mounting block as provided by Corning Gilbert Inc., Glendale, Ariz. In FIG. 3, one interconnect 28 is shown, while in FIG. 4 six interconnects 28 are shown. It should be understood, though, that there can be more positions in the connection block 26 than there are interconnects 28. As such, in FIG. 3, n may equal 6 even though only one interconnect 28 is used. Additionally, each interconnect 28 may be electrically connected to a different antenna 14. Interconnect may be a push-on or a screwed on type interconnect. Interconnect 28 may be a GPO®, GPPO®, G3PO™ or G4PO® Female Blind Mate interconnect as provided by Corning Gilbert Inc., Glendale, Ariz.

Interconnect 28 has a first end 30 and a second end 32. First end 30 attaches to connection block 26 at first side 34. Antenna substrate 22 attaches to connection block 26 at second side 36 and electrically connects with antenna 14. In this manner, first end 30 electrically connects to antenna 14 through connection block 26 in a straight orientation. Interconnect 28 attaches to and electrically connects with other components 18 in structure 20 through respective connectors 38. Connectors 38 may be attached to a surface or a substrate 40 positioned in structure 20. One or more other components 18 may mount to surface 40 and electrically connect to the connectors 38 through wiring, traces or the like. In this manner, second end 32 of interconnect 28 electrically connects to one or more of other components 18 through connector 38, and, thereby, establishes a continuous electrical path from antenna 14 to one or more of other components 18 through interconnect 28 and connector 38. Connector 38 may be a GPO®, GPPO®, G3PO™ or G4PO® Male PCB Edge Mount connector as provided by Corning Gilbert Inc., Glendale, Ariz.

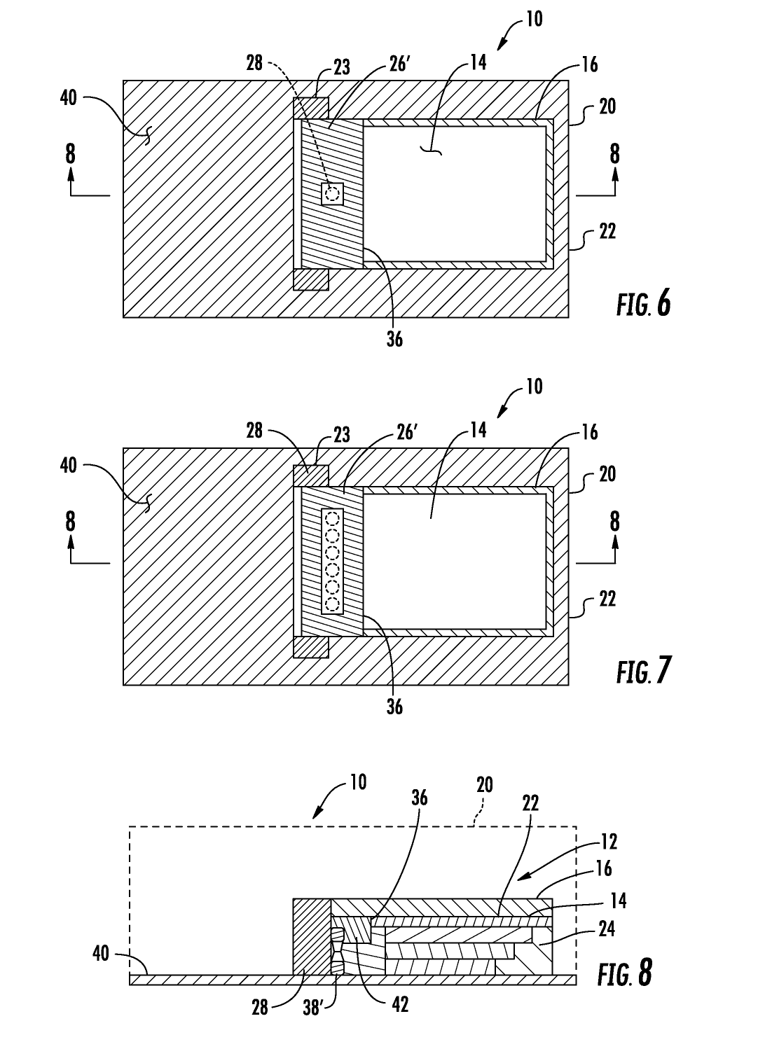

Referring now to FIGS. 6, 7 and 8, there is shown wireless communication system 10 and modular antenna assembly 12 with housing 16 located within or internal to structure 20. Except for differences resulting from the location of the housing 16 within the structure 20, modular antenna assembly 12 is the same as modular antenna assembly 12 of FIGS. 3, 4, and 5. As such, similar aspect as discussed with respect to FIGS. 3, 4 and 5 will not be discussed again with respect to FIGS. 6, 7 and 8. FIGS. 6 and 7 are plan views of housing 16 and structure 20 of wireless communication system 10 showing a general arrangement of interiors of housing 16 and structure 20, while FIG. 8 is a cross-section cut through the housing 16 and structure 20.

In FIGS. 6, 7 and 8, housing 16 is shown using attachment feature 23 to attach to surface 40 instead of to structure 20. Additionally, connection block 26′ has n positions to support n number of interconnects 28 in a right angled connection configuration. In this manner, interconnect 28 may connect to connection block 26′ at the bottom 42 of the connection block 26′, while antenna substrate 22 connects to connection block 26′ at a side 36 of the connection block 26′. Please note that since FIGS. 6 and 7 are top views, bottom 42 would not be visible and, therefore, interconnects 28 are shown with phantom, dashed lines. With particular reference to FIG. 8, then, connection of antenna substrate 22 to second side 36 is shown as on a generally horizontal plane while the connection between interconnect 28 and bottom surface 36 such that interconnect 28 is oriented vertically. In this manner, first end 30 electrically connects to antenna 14 through connection block 26 in a generally 90 degree or right angle orientation. Connection block 26 may be a GPO®, GPPO®, G3PO™ or G4PO® male R/A PCB block assembly as provided by Corning Gilbert Inc., Glendale, Ariz.

Interconnect 28 attaches to and electrically connects with other components 18 on surface 40 through respective connectors 38′. Connectors 38′ may be attached to a surface or a substrate 40 positioned in structure 20. One or more other components 18 may mount to surface 40 and electrically connect to the connectors 38′ through wiring, traces or the like. In this manner, second end 32 of interconnect 28 electrically connects to one or more of other components 18 through connector 38′, and, thereby, establishes a continuous electrical path from antenna 14 to one or more of other components 18 through interconnect 28 and connector 38′. Connector 38′ may be a GPO®, GPPO®, G3PO™ or G4PO® Male PCB Surface Mount connector as provided by Corning Gilbert Inc., Glendale, Ariz.

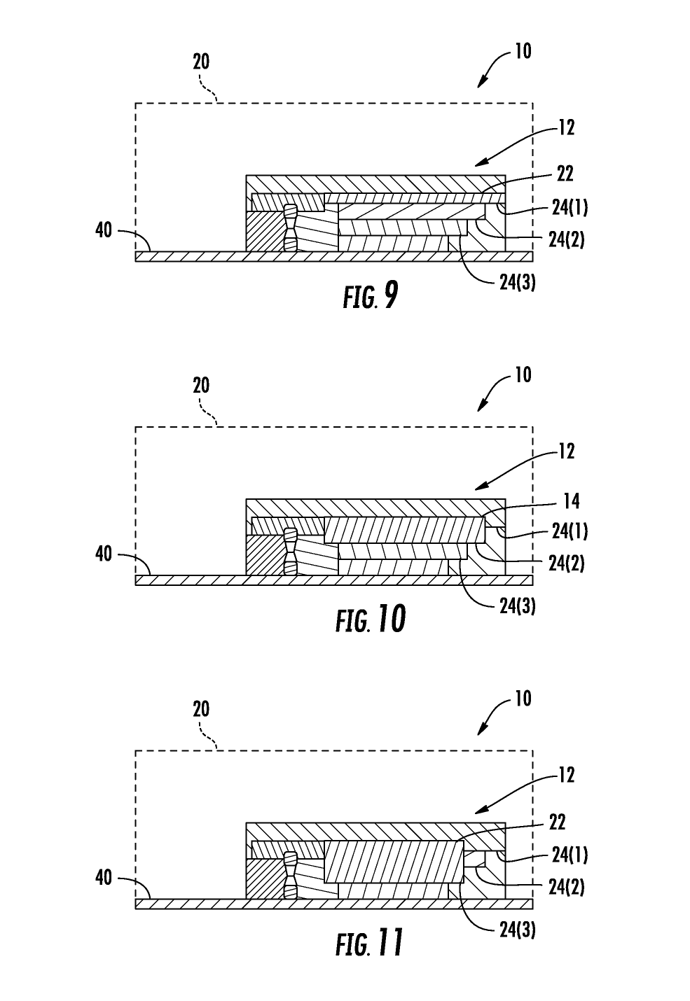

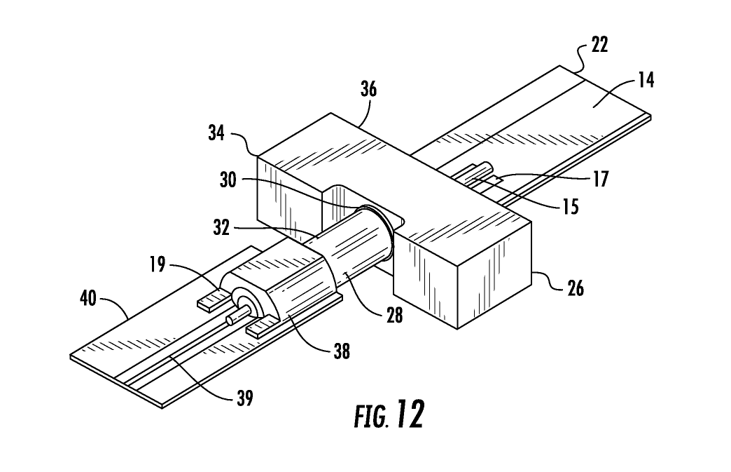

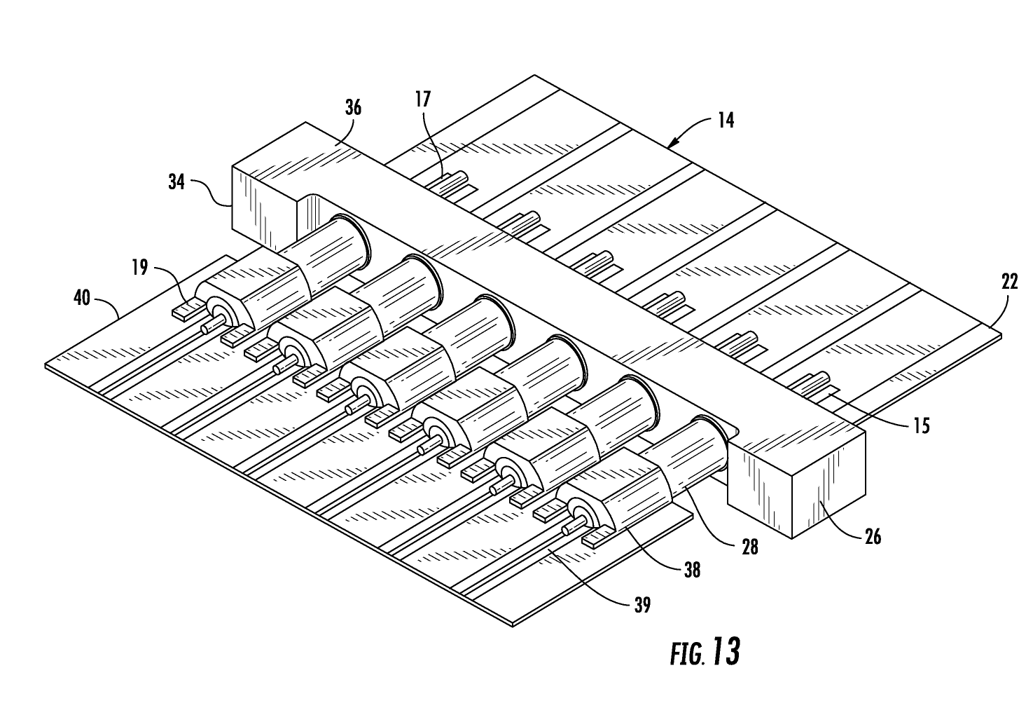

FIGS. 9, 10 and 11 show side, elevation views of modular antenna assembly 12 positioned within or internal to structure 20 mounted to surface 40 and showing antenna substrates 22 mounted on different ones of the plurality of steps 24. The particular step 24 on which antenna substrates 22 mounts is based on the thickness of antenna substrate 22 to orient antenna 14 to an appropriate elevation with respect to other components 18 of wireless communication system 10. In FIG. 9, antenna substrate 22 with a small thickness is shown mounted on top step 24(1). In FIG. 10, antenna substrate 22 with a medium thickness is shown mounted on middle step 24(2). In FIG. 11, antenna substrate 22 with a large thickness is shown mounted on bottom step 24(3). It should be understood that mounting of antenna substrates 22 discussed with respect to modular antenna assembly 12 internal to structure 20 as shown in FIGS. 9, 10 and 11, is similarly applicable to modular antenna assembly 12 external to structure 20.

Steps 24 would serve two functions, to support the antenna substrate 22 on three sides and to support antenna substrate 22 of specific thickness. The ability to mount antenna substrate 22 at different elevations allows for flexibility in the choice of substrate thickness, providing for more design freedom for more efficient antenna specific applications. Accordingly, steps 24 in housing 16 enable a one package solution for different thickness of antenna substrates 22. Mounting of antenna substrate 22 to step 24 may be accomplished using any known, acceptable method, for example, as a non-limiting example, an adhesive which would secure antenna substrate 22 to step 24 and keep antenna substrate 22 stationary.

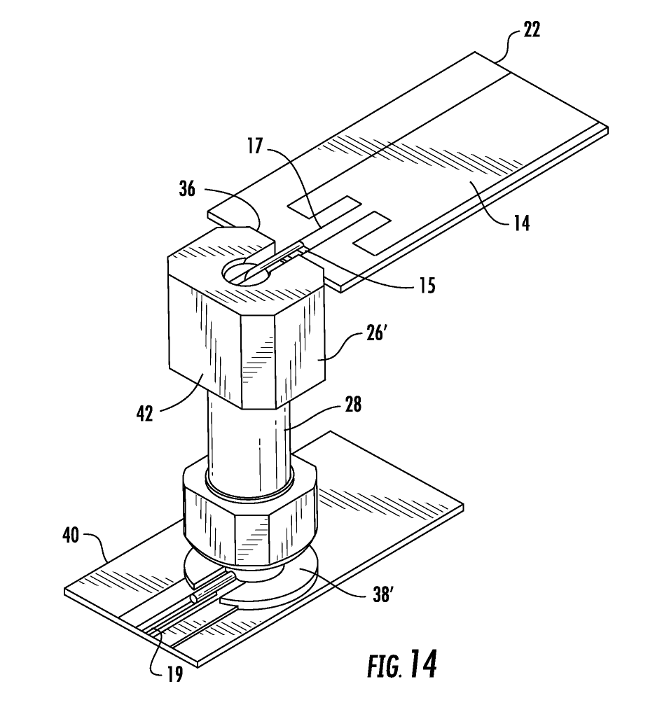

Turning now to FIGS. 12 and 13 there are shown partial perspective views of modular antenna assembly 12 with interconnects 28 connected at first end 30 to connection block 26 to provide for electrical connection to antenna 14 mounted on antenna substrate 22, and at the second end 32 to a male connector 38 to provide connection through a trace 39 to other components (not shown) of the wireless communication system 10 in a straight orientation. FIG. 12 illustrates a single interconnect 28 connection, while FIG. 13 illustrates a plurality of interconnect 28 connections. Although in FIGS. 12 and 13 the number of interconnects is shown as 1 and 6, respectively, modular antenna assembly 12 may be designed for any number of interconnects 28. Connection block 26 has pin 15 extending from second side 36 which connects internally of connection block 26 with a male connector (not shown), incorporated into connection block 26. Pin 15 connects, by soldering or other suitable means, to antenna feed 17, and, thereby, electrically connects antenna 14 to connection block 26.

The male connector in connection block 26 receives the first end 30 of the interconnect 28 at first side 34 and electrically connects to antenna 14 through connection block 26. Connector 38 mounted at the edge of surface 40 connects to interconnect 28 at second end 32. Pin 19 extending from connector 38 connects to trace 39 on surface 40, thereby, electrically connecting trace 39 to interconnect 28 through connector 38. Although not shown in FIGS. 12 and 13, trace 39 connects to one or more of the other components 18 in the wireless communication system 10. In this manner, a continuous electrical connection is established from one or more of the other components 18 to antenna 14 through interconnect 28 in a straight orientation.

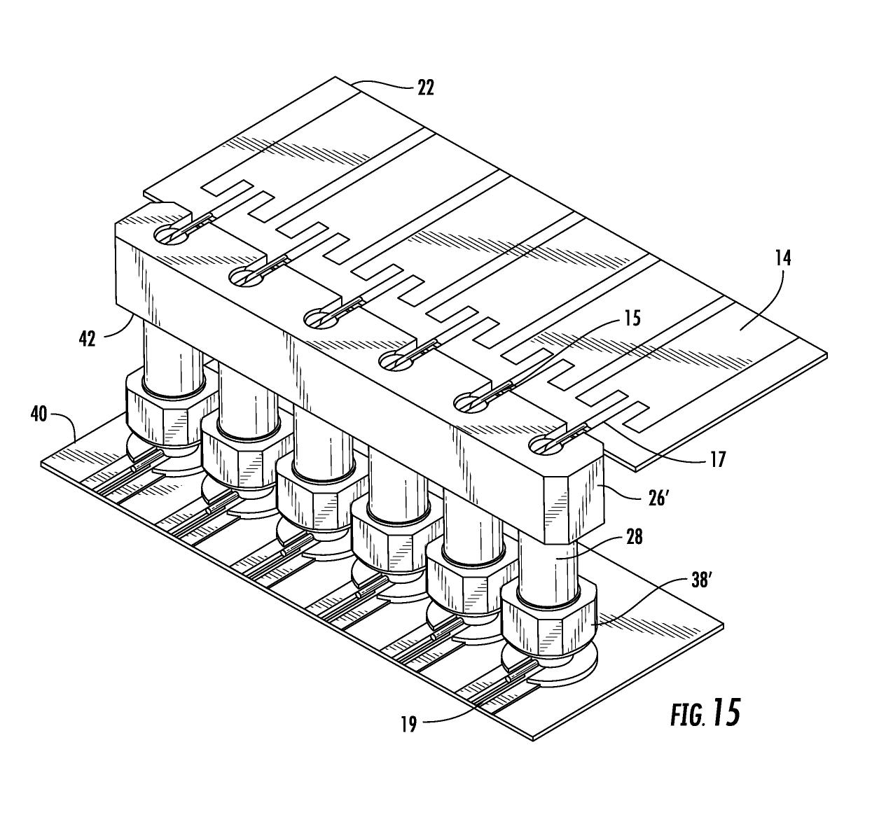

FIGS. 14 and 15 illustrates a similar arrangement as FIGS. 12 and 13 with the exception that the wireless communication system 10 is in a right angle orientation instead of a straight orientation. FIG. 12 illustrates a single interconnect 28 connection, while FIG. 13 illustrates a plurality of interconnect 28 connections. In a right angle orientation, a right angle male connector (not shown) is incorporated into connection block 26′. Although pin 15 extends from second side 36 of connection block 26′ as in a straight orientation and connects to antenna feed 17, first end 30 of interconnect 28 is received by male connector in connection block 26′ at bottom 42 of connection block 26′ instead of at first side 34. Additionally, interconnect 28 connects to connector 38′ which mounts to the surface of surface 40 instead of the edge. Connector 38′ has pin 19 that connects to trace 39, which connects to one or more of the other components 18 in the wireless communication system 10. Accordingly, in a similar fashion to the straight orientation illustrated in FIGS. 12 and 13, a continuous electrical connection is established from one or more of the other components 18 to antenna 14 through interconnect 28, except in a right angle orientation. One example of a benefit involving a right angle orientation, includes two level circuitry applications where antenna 14 occupies the higher level and is connected to the lower active circuitry by interconnect 28 instead of signal and ground vias as is the case in an antenna sandwiched or laminated over the active circuitry, thus eliminating unwanted via parasitics.

Antenna 14 may be any suitable planar antenna 14 for use with a wireless communication system 10 for applications in a broad frequency spectrum from LTE-Band 13 (700 MHz) up to U-Band (40 Ghz-60 GHz) and above. As non-limiting examples, antenna 14 may be a wire type and a monopole or dipole, a micro-trip patch type, a slot type, or the like.

Referring now to FIG. 16 there is shown a front, top, perspective view of housing 16 of modular antenna assembly 12 with removable top 56 (not shown) of housing 16 removed. Housing 16 may be constructed of any material, however, at least one side of the housing 16 is constructed of a non-metallic material to allow for antenna 14 radiation. As an example, the housing 16 may be constructed of molded plastic and formed with a removable front 44, back 46, first side 48, second side 50, and base 52, which define interior 54. Steps 24 may be formed with the housing 16, and, therefore, may be of monolithic construction with the housing 16. Alternatively, steps 24 may be constructed separately from the housing 16 and mounted in the interior 54 of housing 16. Steps 24 are located adjacent to back 46, first side 48 and second side 50 to form a three-segment support extending from base 52 in interior 54. Although in FIG. 16 three steps 24 are shown, housing 16 may have any number of steps 24. Connection block 26 is shown as mounted through front 44 of housing 16. However, connection block 26 may be mounted in other positions in housing 16, as a non-limiting example, thorough base 52, which will be discussed below. Attachment feature 23, shown in FIG. 16 as flanges, may be used to attach the housing 16 to structure 20.

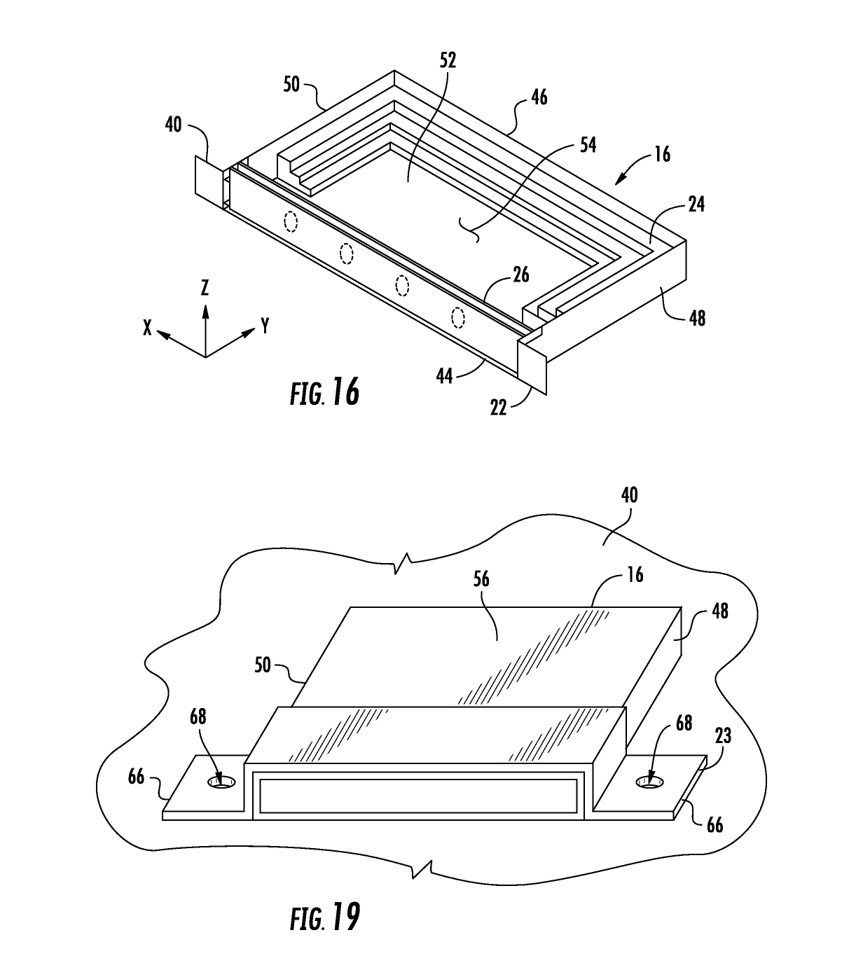

Referring now to FIGS. 17A and 17B there is shown a housing 16 with removable top 56 connected to removable front 44, back 46, first side 48 and second side 50. A generally vertical slot 58 extends through first side 48. A similar slot 58 may extend through second side 50. In FIG. 17A, connection block 26 is shown disassembled from housing 16. Opening 60 extends through front 44. Connection block 26 may be assembled with housing 16 by inserting connection block 26 through slot 58 and positioning connection block 26 to align with opening 60 as is shown in FIG. 17B. In this manner, interconnects 28 connected to connection block 26 may extend through opening 60. The housing 16 shown in FIGS. 17A and 17B may be used when the housing 16 is located outside of or external to structure 20.

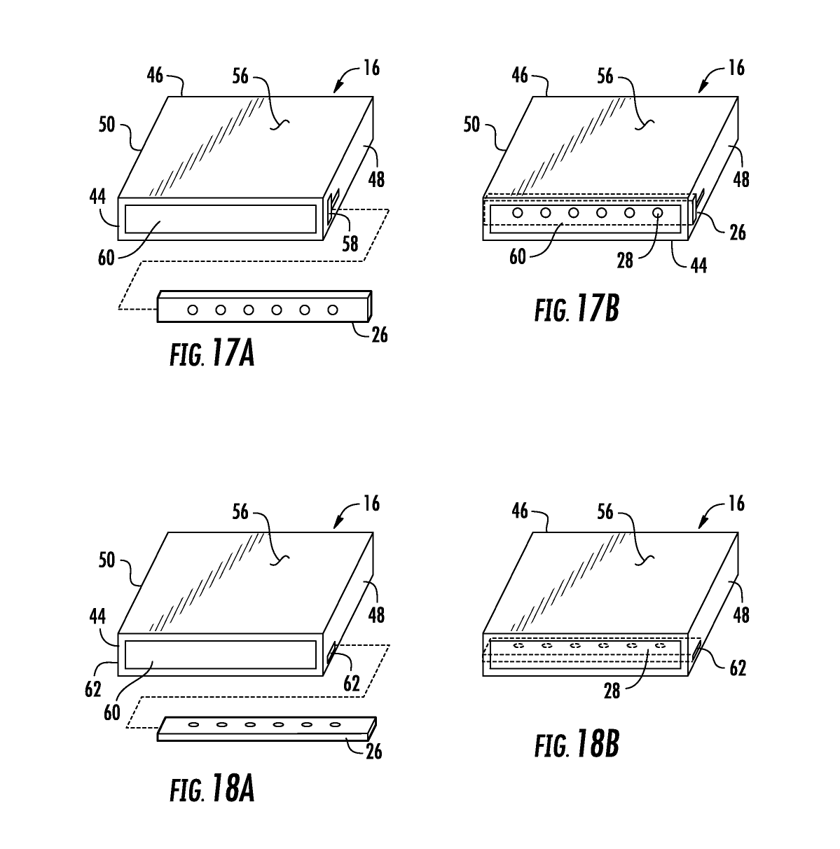

Referring now to FIGS. 18A and 18B there is shown a housing 16 with top 56 similar to that shown in FIGS. 18A and 18B, except that the front 44 has been removed. A generally horizontal slot 62 extends through first side 48. A similar slot 62 may extend through second side 50. In FIG. 18A, connection block 26′ is shown disassembled from housing 16. Opening 64 extends through base 52 proximate to front 44. Connection block 26′ may be assembled with housing 16 by inserting connection block 26′ through slot 62 and positioning connection block 26′ to align with opening 64 as is shown in FIG. 18B. In this manner, interconnects 28 positioned in connection block 26′ may extend through opening 64 in base 52. The housing 16 shown in FIGS. 18A and 18B may be used when the housing 16 is located within or internal to structure 20.

FIG. 19 illustrates housing 16 of modular antenna assembly 12 with attachment feature 23. Attachment feature 23 is in the form of a bracket positioned around top 56, first side 48 and second side 50 of housing 16 with flanges 66 having holes 68. In this regard, housing 16 may be internal to structure 20 (not shown) and be releasably attached to surface 40 by fasteners (not shown) inserted through holes 68 and into surface 40.

In either a straight orientation or a right angle orientation, modular antenna assembly 10 may be disconnected from the structure 20, and, thereby, the other components 18 of the wireless communication system 10 by simply disconnecting the attachment feature 23 and interconnect 28 from the connector 38, 38′. In this way, the modular antenna assembly 12 may be separated from the rest of the wireless communication system 10. A modular antenna assembly 12 allows for a change to an antenna 14 with a better radiative signature. The field of antenna design is ever evolving with superior antenna performance such as higher gain and larger bandwidth using the same form-factor by change of substrate type or antenna design. In this way, modular antenna assembly 12 can be easily exchanged for one having a newer and a better antenna 14 without discarding the other components 18 of the wireless communication system 10, thus creating a cost savings. Such modular antenna assemblies 12, may also help quick testing of antenna 14 performance in a R&D type testing environment. Also, if such new antenna 14 would require the same form-factor as the old antenna 14, just the antenna 14 can be exchanged keeping the rest of the modular antenna assembly 12.

Additionally, the ever increasing implementation of MIMO (Multiple Input and Multiple Output antenna) systems would require more space and dedicated antenna platforms to realize the theoretical advantage promised by the MIMO technology. Modulator antenna assembly 12 would help in an easy and efficient implementation of MIMO and LTE technology utilizing MIMO. Physical separation of the antenna 14 from the active electronic circuitry onto an antenna substrate 22 separate from surface 40 would prevent and arrest the common substrate parasitic coupling between the antenna 14 and other active elements mounted on the surface 40, and thus improve the performance of the wireless communication system 10.

The method of changing the modular antenna assembly 12 comprises the steps of detaching the attachment feature 23 so that the housing 16 is not attached to the structure 20 (Step 1); disconnecting the interconnect 28 from the connection block 26, 26′ at the interconnect 28 first end 30 (step 2); separating housing 16 from structure 20 (step 3); removing existing modular antenna assembly 12 from housing 16 (step 4); installing new modular antenna assembly 12 in housing (step 5); connecting the interconnect 28 to the new connection block 26, 26′ at first end 30 (step 6); and attaching housing 16 to structure 20 using attachment feature 23 (step 7).

The method of replacing only antenna substrate 22 and antenna 14 comprises the steps of detaching the attachment feature 23 so that the housing 16 is not attached to the structure 20 (Step 1); disconnect the interconnect 28 from the connection block 26, 26′ at the interconnect 28 first end 30 (step 2); removing top 56 of housing 16 (step 3); un-soldering the connections between pin 15 and antenna feed region 17 (step 4); removing any adhesive between the antenna (14) and step 24 on which antenna is positioned in housing 16 (step 5); removing the connection block 26, 26′ from housing 16 (step 6); removing the old antenna substrate 22 (step 7); installing new antenna substrate 22 with new antenna 14 in housing 16 on one of the steps 24 using adhesive (step 7); adjusting connection block 26, 26′ to be able to solder pins 15 (step 8); soldering pins 15 to respective feed region 17 (step 9); placing top 56 on housing 16 (step 10); connecting interconnect 28 to the connection block 26, 26′ at first end 30 (step 11); and attaching housing 16 to structure 20 using attachment feature 23 (step 12)

Many modifications and other embodiments will come to mind to one skilled in the art to which the embodiments set forth herein pertain having the benefit of the teachings presented in the foregoing descriptions and the associated drawings. Therefore, it is to be understood that the description and claims are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A modular antenna assembly for a wireless system, comprising:
an antenna substrate having an antenna formed thereon; and
an interconnect configured to releasably attach the antenna substrate to another component of the wireless system, wherein the antenna is electrically connected to the another component through the interconnect.

2. The modular antenna assembly of claim 1, wherein the interconnect is a push-on interconnect.

3. The modular antenna assembly of claim 1, wherein the interconnect is a screw-on interconnect.

4. The modular antenna assembly of claim 1, further comprising a connection block, wherein the interconnect attaches to the antenna substrate through the connection block.

5. The modular antenna assembly of claim 1, wherein the another components comprises a non-radiative component.

6. The modular antenna assembly of claim 1, further comprising an housing, wherein the antenna substrate is positioned in the housing.

7. The modular antenna assembly of claim 6, wherein the housing separates the antenna assembly from the another component of the wireless system.

8. The modular antenna assembly of claim 7, wherein the housing is located externally from a structure in which the another component is located.

9. The modular antenna assembly of claim 7, wherein the housing is located internally to a structure in which the another component is located.

10. The modular antenna assembly of claim 9, wherein the housing is mounted to a substrate on which the another component is mounted.

11. The modular antenna assembly of claim 10, further comprising a bracket, wherein the bracket is configured to mount the housing to the substrate.

12. A modular antenna assembly for a wireless system, comprising:
an housing;
an antenna substrate having an antenna formed thereon and mounted in the housing;
a connection block attached to the antenna substrate; and
a push-on interconnect having a first end and a second end and is electrically connected to the antenna through the connection block at the first end and is configured to releasably attach the antenna substrate to another component of the wireless system, wherein the antenna electrically connects to the another component through the push-on interconnect at the second end, and wherein the another component is attached to a structure.

13. The modular antenna assembly of claim 12, wherein the push-on interconnect is a straight interconnect, wherein an axis through the first end and an axis through the second end align, generally.

14. The modular antenna assembly of claim 12, wherein the push-on interconnect is a right angle straight interconnect, wherein an axis through the first end and an axis through the second end form a right angle, generally.

15. The modular antenna assembly of claim 12, further comprising a plurality of steps formed in the housing, wherein the antenna substrate mounts on one of the plurality of steps.

16. The modular antenna assembly of claim 15, wherein the plurality of steps provide antenna elevation differences from a reference in the structure where the another component is attached to provide selective antenna gain adjustment.

17. The modular antenna assembly of claim 15, wherein the thickness of the antenna substrate is adjusted based on which of the plurality of steps the antenna substrate mounts.

18. The modular antenna assembly of claim 12, wherein the antenna is a wire type.

19. The modular antenna assembly of claim 18, wherein the antenna is a monopole type.

20. The modular antenna assembly of claim 18, wherein the antenna is a dipole type.

21. The modular antenna assembly of claim 12, wherein the antenna is a micro-strip patch type.

22. The modular antenna assembly of claim 12, wherein the antenna is a slot-antenna.

23. The modular antenna assembly of claim 12, wherein the antenna operates across a frequency range of about 0.7 GHZ to 70 GHz.
